(19) United States
(12) Patent Application Publication
(10) Pub. No.: US 2016/0002495 A1
(43) Pub. Date: Jan. 7, 2016

(54) POLYURETHANE SOUND-INSULATING COMPOSITION AND METHOD OF MANUFACTURING SOUND-ABSORBING AND INSULATING MATERIAL FOR VEHICLES USING THE SAME

(71) Applicant: DAEHAN SOLUTION CO., LTD, Incheon (KR)

(72) Inventors: Choong Ho KWON, Seoul (KR); Jang Seok PARK, Incheon (KR)

(73) Assignee: DAEHAN SOLUTION CO., LTD, Incheon (KR)

(21) Appl. No.: 14/755,445

(22) Filed: Jun. 30, 2015

(30) Foreign Application Priority Data
Jul. 7, 2014 (KR) 10-2014-0084334

(51) Int. Cl. C09D 175/04; B05D 1/02; C08K 3/34; C08K 3/30; C08K 3/26

(52) U.S. Cl. CPC C09D 175/04; C08K 3/30; C08K 3/26; C08K 3/34; B05D 1/02; C08K 2003/265; C08K 2003/3045

(57) ABSTRACT

A liquid polyurethane sound-insulating composition prepared by forming a urethane bond between a polyether polyol resin and modified methylene bisphenyl diisocyanate and uniformly dispersing an inorganic filler and a method of manufacturing a sound-absorbing and insulating material for vehicles, and therefore various types of sound-absorbing and insulating materials may be manufactured with no scraps by spray-coating a surface of a sound-absorbing material with the polyurethane sound-insulating composition, and sound-insulating performance with respect to a weight of the composition. Particularly, provided are a polyurethane sound-insulating composition which may be partially spray-coated on a part requiring sound-insulating performance, rather than being spray-coated on an entire surface of a sound-absorbing material, thereby minimizing an increase in weight and maximizing the sound-insulating performance, and a method of manufacturing a sound-absorbing and insulating material for vehicles.

### CROSS-REFERENCE TO RELATED APPLICATION

This application claims priority to and the benefit of Korean Patent Application No. 10-2014-0084334, filed on Jul. 7, 2014, the disclosure of which is incorporated herein by reference in its entirety.

### BACKGROUND

1. Field of the Invention

The present invention relates to a polyurethane sound-insulating composition and a method of manufacturing a sound-absorbing and insulating material for vehicles. A polyurethane sound-insulating layer is formed by spray-coating a composition prepared by previously forming a urethane bond between a polyether polyol resin and modified methylene bisphenyl diisocyanate and adding and evenly distributing an inorganic filler in the above mixture, and thus improved sound-insulating performance, a light weight, odor removal, and improvement in processability, flexibility and physical properties may be obtained.

2. Discussion of Related Art

Generally, to prevent transmission of noise generated in an engine or noise generated outside of a vehicle into the vehicle, an engine room and an interior floor of a trunk are equipped with a sound-absorbing and insulating material. Such a sound-absorbing and insulating material is installed by separately manufacturing a sheet conventionally having a sound-absorbing function and a sheet conventionally having a sound-insulating sheet, or by integrating a sheet conventionally having a sound-absorbing function and a sheet conventionally having a sound-insulating sheet. Here, as the sound-insulating material used herein, as disclosed in Korean Patent Nos. 031614 (registration date: Nov. 15, 2001) and 0598520 (registration date: Jul. 3, 2006), Korean Patent Publication No. 10-2009-0062024 (publication date: Jun. 17, 2009) and Korean Patent No. 1317818 (registration date: Oct. 7, 2013), poly vinyl chloride (PVC), nature rubber (NR), ethylene vinyl acetate (EVA), etc. are generally used.

However, press molding is difficult when PVC is formed in a sheet, a degree of freedom in shape is not precise, many scraps are generated, and recycling is restricted, and thus use of PVC as a sound-insulating material is currently decreasing. NR is expensive, but its sound insulating effect with respect to a cost is still poor, and particularly, it is heavy, which affects gas mileage. While EVA is preferable to these other sound-insulating materials, it still requires further improvements in sound-insulating performance, cost reduction, weight reduction, and excellence in processability.

Accordingly, development of a sound-insulating material that, unlike such conventional sound-insulating materials, has enhanced sound-insulating performance with respect to a weight is required.

### SUMMARY OF THE INVENTION

The present invention is directed to providing a liquid polyurethane sound-insulating composition prepared by forming a urethane bond between a polyether polyol resin and modified methylene bisphenyl diisocyanate and uniformly dispersing an inorganic filler therein and a method of manufacturing a sound-absorbing and insulating material for vehicles, and therefore various types of sound-absorbing and insulating materials may be manufactured without scraps by spray-coating a surface of a sound-absorbing material with the polyurethane sound-insulating composition, and sound-insulating performance with respect to a weight of the composition may be improved.

Particularly, the present invention is also directed to providing a polyurethane sound-insulating composition which may be partially spray-coated on a part requiring sound-insulating performance rather than being spray-coated on an entire surface of a sound-absorbing material, thereby minimizing an increase in weight and maximizing the sound-insulating performance, and a method of manufacturing a sound-absorbing and insulating material for vehicles.

In one aspect, a polyurethane sound-insulating composition of the present invention includes a polyether polyol resin at 15 to 30 wt %, modified methylene bisphenyl diisocyanate at 10 to 25 wt %, and an inorganic filler at 55 to 75 wt %.

Particularly, the inorganic filler is prepared of at least one of barium sulfate (BaSO₄), calcium carbonate (CaCO₃) and mica, or prepared by mixing barium sulfate (BaSO₄) and calcium carbonate (CaCO₃) at a ratio of 1:99 to 99:1. Here, the sound-insulating composition has a specific gravity of 1.0 to 2.0.

In another aspect, a method of manufacturing a sound-absorbing and insulating material for vehicles using the polyurethane sound-insulating composition according to the present invention includes forming a first sound-insulating layer 20 by spray-coating the above-described polyurethane sound-insulating composition on a surface of a first sound-absorbing layer 10.

In addition, a second sound-absorbing layer 30 is further stacked on the first sound-insulating layer 20. In addition, a second sound-insulating layer 40 is further included between the first sound-insulating layer 20 and the second sound-absorbing layer 30.

In the method of manufacturing a sound-absorbing and insulating material for vehicles according to the present invention, in the first sound-insulating layer 20, the polyether polyol resin, the modified methylene bisphenyl diisocyanate, and the inorganic filler are as shown in the following table:

| | | |
|---|---|---|
| Sprayed amount | 80~120 | g/s |
| Particle size of inorganic filler | 40 to 45 | μm |

| | | | |
|---|---|---|---|
| Pressure | Polyether polyol resin | 160 to 200 | bar |
| | Modified methylene bisphenyl | 180 to 240 | bar |
| | diisocyanate | | |
| Temperature | Polyether polyol resin | 60 to 70° | C. |
| | Modified methylene bisphenyl | 35 to 45° | C. |
| | diisocyanate | | |
| Viscosity | Polyether polyol resin | 1215 | MPa · s |
| | Modified methylene bisphenyl | 470 | MPa · s |
| | diisocyanate | | |

1) Sprayed amount: an amount of a sound-insulating composition according to the present invention that is sprayed to form a sound-insulating layer 20.
2) The inorganic filler is barium sulfate (BaSO₄).
3) The viscosity is measured at 25° C.

In the method according to the present invention, a polyether polyol resin is bound to modified methylene bisphenyl diisocyanate obtained by a reaction of polypropylene glycol to form a urethane bond under the above conditions, for example, the temperature, pressure, and viscosity described above, an inorganic filler is added thereto, and then the resulting product is spray-coated.

In addition, the second sound-absorbing layer 30 is hard PET, and the second sound-insulating layer 40 is a TPE sheet or heavy layer.

Finally, the first sound-insulating layer 20 is spray-coated on 70 to 100% of the entire surface of the first sound-absorbing layer 10 to a thickness of 0.5 to 3.0 mm.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a cross-sectional view of a sound-absorbing and insulating material of Example 1 manufactured by spray-coating a sound-absorbing material with a polyurethane sound-insulating composition according to the present invention;

FIG. 2 is a cross-sectional view of a sound-absorbing and insulating material of Example 2 manufactured by spray-coating a sound-absorbing material with a polyurethane sound-insulating composition according to the present invention;

FIGS. 3 to 5 show results obtained by measuring an articulation index (AI) according to a speed (rpm) by equipping actual vehicles with sound-absorbing and insulating materials of Example 2 according to the present invention and a comparative example, in which FIG. 3 shows an AI measured at a driver's seat, FIG. 4 shows an AI measured at a passenger's seat, and FIG. 5 shows an AI measured in the center of a back seat;

FIG. 6 is a cross-sectional view of a sound-absorbing and insulating material of Example 3 manufactured by spray-coating a sound-absorbing material with the polyurethane sound-insulating composition according to the present invention; and

FIGS. 7 to 9 show results obtained by measuring an AI in three-step rapid acceleration by equipping actual vehicles with sound-absorbing and insulating materials of Example 3 according to the present invention and a comparative example, in which FIG. 7 is an AI measured at a driver's seat, FIG. 8 is an AI measured at a passenger's seat, and FIG. 9 shows an AI measured in the center of a back seat.

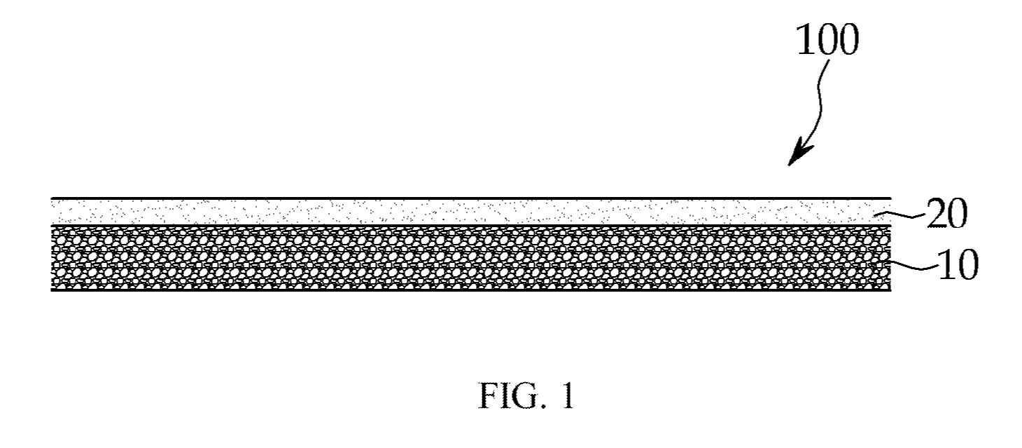

### DETAILED DESCRIPTION OF EXEMPLARY EMBODIMENTS

Hereinafter, exemplary embodiments of the present invention will be described in further detail with reference to the accompanying drawings. It should be noted first that terms and words used herein and in the claims should not be interpreted as being limited to a conventional or literal meaning, but should be interpreted with meanings and concepts which are consistent with the technological scope of the invention based on the principle that the inventors have appropriately defined concepts of terms in order to describe the invention in the best way.

Accordingly, since configurations illustrated in examples described in the specification and the drawings are merely the most exemplary embodiments of the present invention and do not represent the entire technical idea of the present invention, it should be understood that there may be various equivalents and modifications capable of replacing them at the time of application.

[Polyurethane Sound-Insulating Composition]

The polyurethane sound-insulating composition according to the present invention includes a polyether polyol resin at 15 to 30 wt %, modified methylene bisphenyl diisocyanate at 10 to 25 wt %, and an inorganic filler at 55 to 75 wt %.

Particularly, in the present invention, a dense coating film (sound-insulating layer) may be formed by performing spray-coating with a composition prepared by forming a urethane bond between a polyether polyol resin and modified methylene bisphenyl diisocyanate at a predetermined temperature and pressure and uniformly mixing an inorganic filler therein.

The present invention will be described in further detail.

In the present invention, as main binders, polyether polyol and modified methylene bisphenyl diisocyanate, which are suitable for a spray process, are used. Particularly, the polyether polyol resin is known to have a molecular weight, a hydroxyl value (OHV) and a functional group, which are suitable for reaction injection molding (RIM) and a spray process.

Modified methylene bisphenyl diisocyanate has excellent mechanical strength and fast reactivity, and thus has an isocyanate content (NCO %) suitable for a spray process, and as the modified methylene bisphenyl diisocyanate, a prepolymer type prepared by reacting a small amount of polypropylene glycol having an isocyanate index is used.

As the inorganic filler, barium sulfate (BaSO₄), calcium carbonate (CaCO₃) or mica may be used alone or in combinations of at least two thereof. For example, a mixture of barium sulfate (BaSO₄) and calcium carbonate (CaCO₃) at a ratio of 1:99 to 99:1 may be used as the inorganic filler.

Such a polyurethane sound-insulating composition is spray-coated on a surface of a sound-absorbing material to form a sound-insulating layer, and the formation of such a sound-insulating layer will be described in detail in the method of manufacturing sound-absorbing and insulating materials according to the present invention.

In addition, in an exemplary embodiment of the present invention, the polyurethane sound-insulating composition may be prepared to have a specific gravity of 1.0 to 2.0. This minimizes an increase in weight of the sound-absorbing and insulating material according to the present invention, improves gas mileage, and improves sound-insulating performance.

### Example 1 of Sound-Absorbing and Insulating Material

A sound-absorbing and insulating material 100 according to Example 1 of the present invention includes a first sound-insulating layer 20 formed by spray-coating the above-described polyurethane sound-insulating composition according to the present invention on a surface of a first sound-absorbing layer 10.

Here, any material having sound-absorbing performance may be used as the first sound-absorbing layer 10, and in an exemplary embodiment of the present invention, a polyurethane foam or hard polyethylene terephthalate (PET) may be used.

Meanwhile, the first sound-insulating layer 20 may be formed according to a composition of the polyurethane sound-insulating composition according to the present invention, and formed by mixing the following compounds under the following conditions shown in Table 1 and uniformly dispersing the inorganic filler such that it can be easily sprayed on the first sound-absorbing layer 10. Contents of the polyether polyol resin, the modified methylene bisphenyl diisocyanate and the inorganic filler were already described in the descriptions of the “polyurethane sound-insulating composition,” and conditions for uniform distribution and spray-coating other than the composition ratio are shown in Table 1.

TABLE 1

| Sprayed amount | | 80~120 | g/s |
|---|---|---|---|
| Particle size of inorganic filler | | 40 to 45 | μm |
| Pressure | Polyether polyol resin | 160 to 200 | bar |
| | Modified methylene bisphenyl | 180 to 240 | bar |
| | diisocyanate | | |
| Temperature | Polyether polyol resin | 60 to 70° | C. |
| | Modified methylene bisphenyl | 35 to 45° | C. |
| | diisocyanate | | |
| Viscosity | Polyether polyol resin | 1215 | MPa · s |
| | Modified methylene bisphenyl | 470 | MPa ·s |
| | diisocyanate | | |

1) Sprayed amount: an amount of a sound-insulating composition according to the present invention that is sprayed to form a sound-insulating layer 20.
2) The inorganic filler is barium sulfate (BaSO₄).
3) The viscosity is measured at 25° C.

Particularly, the first sound-insulating layer 20 according to the present invention facilitates distribution of and spray-coating with a composition prepared by forming a urethane bond between the polyether polyol resin and the modified methylene bisphenyl diisocyanate under the temperature, pressure and viscosity conditions, adding the inorganic filler thereto, and uniformly dispersing it therein.

Accordingly, the sound-absorbing and insulating material 100 according to the present invention may obtain sound-absorbing performance through the first sound-absorbing layer 10 as in the conventional art, and may also obtain sound-insulating performance through the first sound-insulating layer 20.

Particularly, the first sound-insulating layer 20 according to the present invention is formed through spray-coating, and thus may be formed by performing spray-coating on a desired position regardless of a shape of the sound-absorbing layer 10, resulting in an increase in a degree of freedom in shape.

In addition, in an exemplary embodiment of the present invention, the first sound-insulating layer 20 may be spray-coated on 70 to 100% of an entire surface of the first sound-absorbing layer 10, thereby minimizing a weight increase and increasing a sound-insulating effect. Here, after a part requiring sound insulation is identified through an actual sound insulation test when an actual vehicle is equipped with the sound-absorbing and insulating material 100 according to the present invention, the sound-insulating layer is formed only in the part requiring sound insulation.

Finally, in addition to the partial spray-coating described above, in an exemplary embodiment of the present invention, the first sound-insulating layer 20 may also be spray-coated to a thickness of 0.5 to 3.0 mm in order to minimize a weight increase and improve sound-insulating performance.

### Example 2 of Sound-Absorbing and Insulating Material

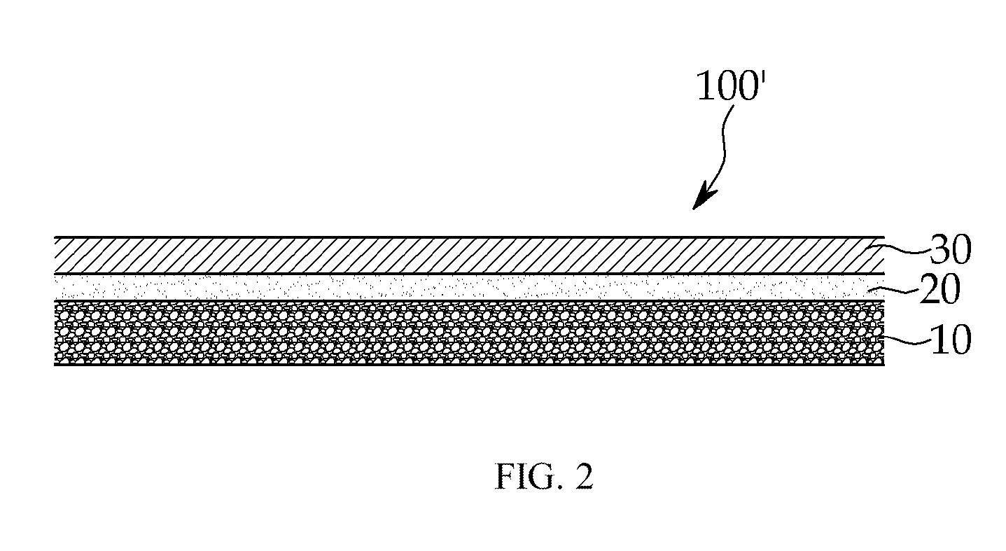

Compared to Example 1, a sound-absorbing and insulating material 100′ according to Example 2 of the present invention further includes a second sound-absorbing layer 30 on a first sound-insulating layer 20 as shown in FIG. 2.

Here, the second sound-absorbing layer 30, like the above-described first sound-absorbing layer 10, may be formed of any material having sound-absorbing performance, but in an exemplary embodiment of the present invention, for example, a polyurethane foam and hard PET may be used.

In addition, in Example 2, the first sound-absorbing layer 10 and the second sound-absorbing layer 30 may be formed of the same materials or different materials.

(Field Test for Sound-Absorbing and Insulating Material According to Example 2)

Performances of the sound-absorbing and insulating materials according to an example of the present invention and a comparative example with which an actual vehicle is equipped are compared by measuring an articulation index (AI). Here, the AI is a ratio between conversation and environmental noise, that is, a signal-to-noise ratio, and a ratio of 0% refers to a state in which conversation is difficult while a ratio of 100% refers to a state in which conversation is entirely unimpeded.

This AI value is obtained by measuring a speed (rpm) change in a field state when three different positions in a vehicle (Forte 5-Door GSL MPI 2.0/6 AT) are equipped with microphones. In addition, the three microphones are installed near the heads of passengers seated in a driver's seat and a passenger's seat and at the center of a back seat.

In addition, samples of the example and the comparative example used in the measurement of AIs are shown in Table 2.

TABLE 2

| | Specification | | | |
|---|---|---|---|---|
| | | First | First | |
| | | sound- | sound- | |
| | Second sound- | insulating | absorbing | |
| Category | absorbing layer | layer | layer | Weight |
| Comparative | Hard PET | TPE (1 T) | Polyurethane | 3.9 kg |
| example | (800 g/m²) | | foam | |
| | | | (d: 100 g/m²) | |
| Example | | Sprayed PU | Polyurethane | 2.8 kg |
| | | (0.2 to 0.3 T) | foam | |
| | | | (d: 100 g/m²) | |

1) Sprayed PU in the example is a sound-insulating layer formed by performing spray-coating with the polyurethane sound-insulating composition according to the present invention.

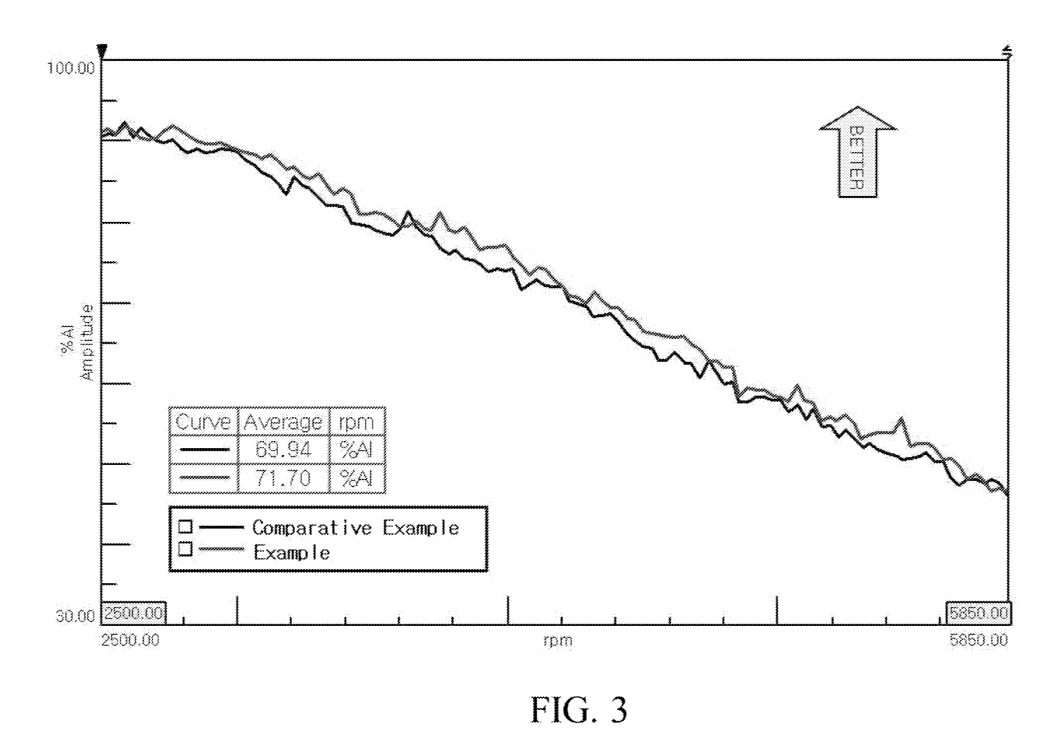

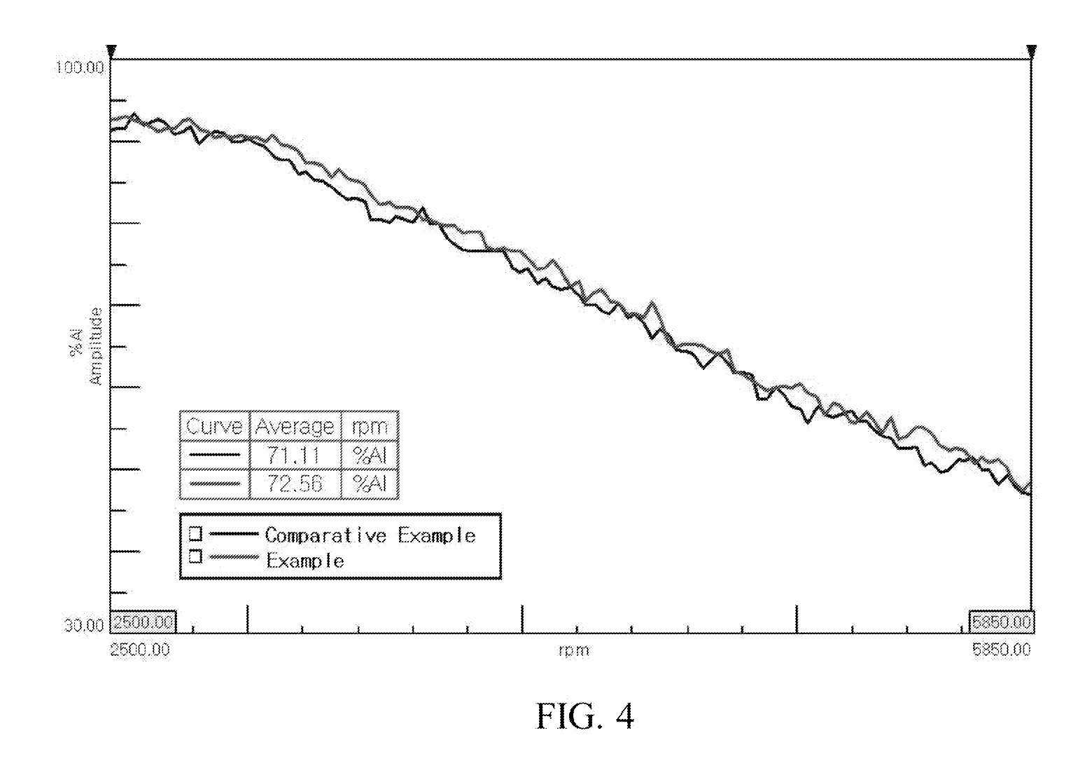

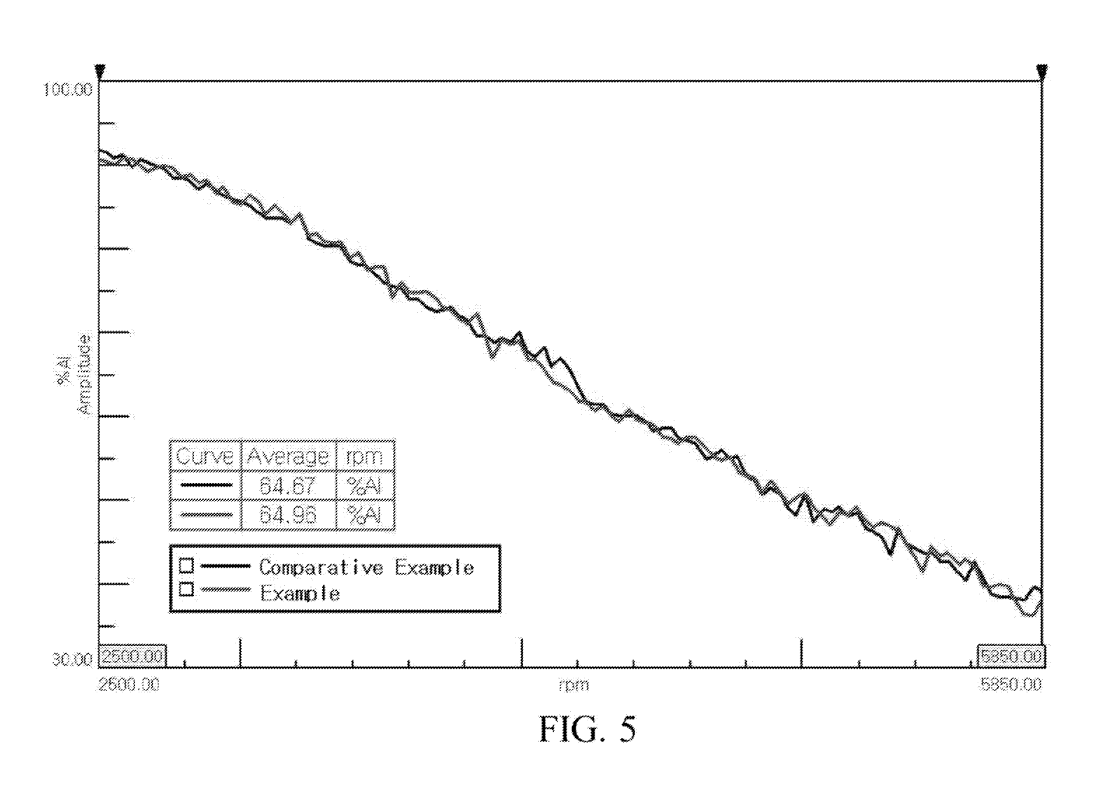

Results of the field test are shown in FIGS. 3 to 5. FIG. 3 shows the AI measured at the driver's seat, FIG. 4 is the AI measured at the passenger's seat, and FIG. 5 is the AI measured in the center of the back seat.

Referring to FIGS. 3 to 5, it can be noted that the AI at the passenger's seat decreases somewhat, but the AI of the example represented with a red line is higher than that of the comparative example represented with a black line.

This is because, although the sound-absorbing layers are identical in the example and the comparative example, the sound-insulating layers between the sound-absorbing layers are different. Particularly, it can be noted that, in the example, the weight are less than that of the comparative example.

Accordingly, it can be noted that, in Example 2, the increase in weight are minimized and the sound-insulating performance are improved, compared to the comparative example. As a result, according to the AI, it is noted that, compared to the comparative example, the example shows excellent NVH performance with respect to a weight only with the increase in a weight of 400 g (it can be noted that the AI measured by applying the sound-absorbing and insulating material of the example to an actual vehicle maximally increases 1.76%).

### Example 3 of Sound-Absorbing and Insulating Material

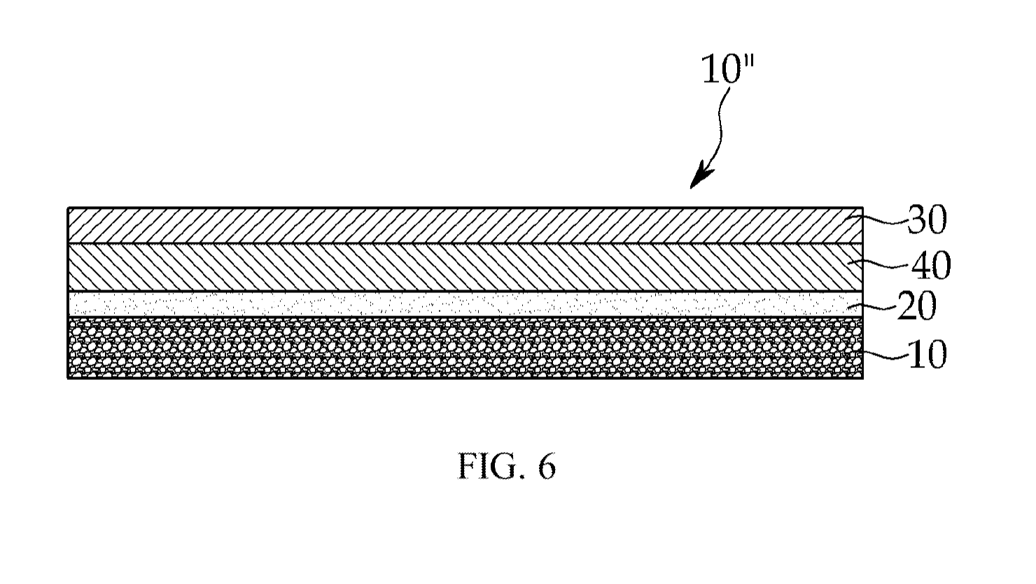

Compared to Example 2, a sound-absorbing and insulating material 100″ according to Example 3 of the present invention may further include a second sound-insulating layer 40 between a first sound-insulating layer 20 and a second sound-absorbing layer 30 as shown in FIG. 6. Here, detailed description of the same components as in Example 2 will be omitted.

In an exemplary embodiment of the present invention, as the second sound-insulating layer 40, a TPE sheet or a heavy layer may be used.

Therefore, sound-insulating performance may be further improved in the sound-absorbing and insulating material 100″ according to Example 3 using a bilayered sound-insulating layer.

(Field Test for Sound-Absorbing and Insulating Material According to Example 3)

Performances of the sound-absorbing and insulating materials according to an example according to the present invention and a comparative example with which an actual vehicle is equipped are compared through a result obtained by measuring an AI, and are as follows.

Such an AI is a value obtained by measuring a change in articulation when microphones are installed in three different positions in a vehicle and the vehicle is driven on a road in a field state. In addition, the three microphones are installed near the heads of passengers seated in a driver's seat and a passenger's seat and at the center of a back seat.

In addition, samples of the example and the comparative example used in the measurement of AIs are shown in Table 3.

TABLE 3

| | Specification | | | | |
|---|---|---|---|---|---|
| | Second | Second | First | First | |
| | sound- | sound- | sound- | sound- | |
| | absorbing | insulating | insulating | absorbing | |
| Category | layer | layer | layer | layer | Weight |
| Comparative | Hard PET | TPE | x | Poly- | 5.9 kg |
| example | (1,200 g/m²) | (1.5 T) | | urethane | |
| Example | | | Partial | foam | 6.7 kg |
| | | | sound | (d: | |
| | | | insulation | 100 g/m²) | |
| | | | (d: | | |
| | | | 102 g/m²) | | |

1) Partial sound insulation in the example (first sound-insulating layer) is obtained by partially spray-coating the first sound-absorbing layer with the polyurethane sound-insulating composition according to the present invention.

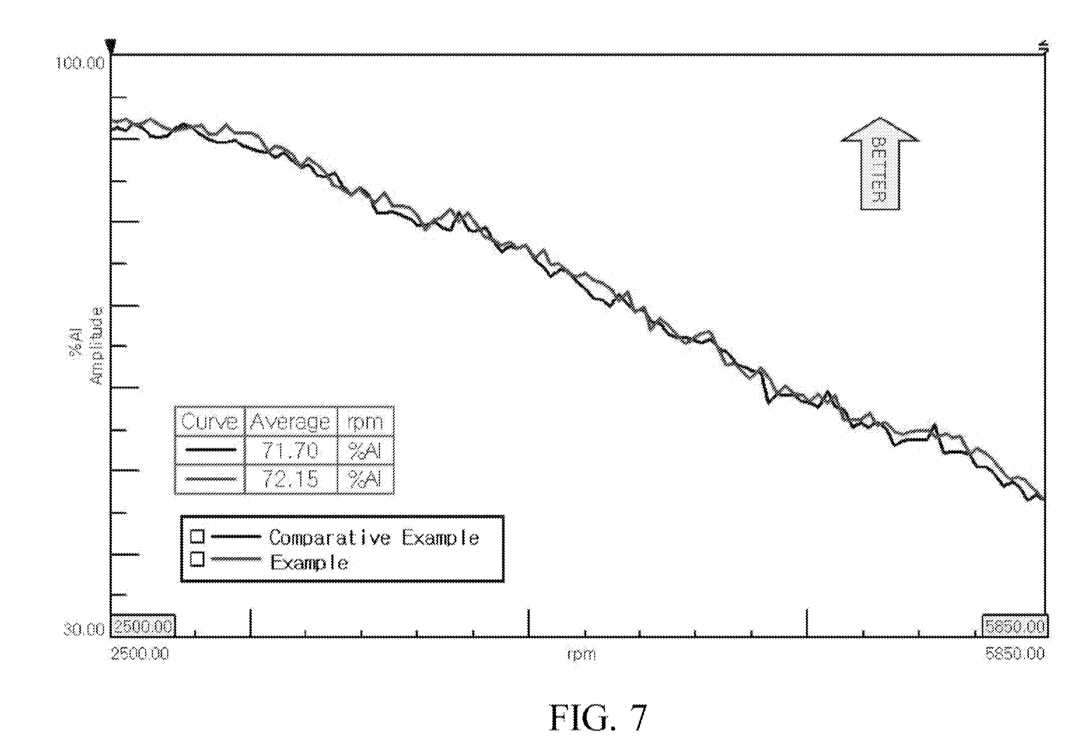

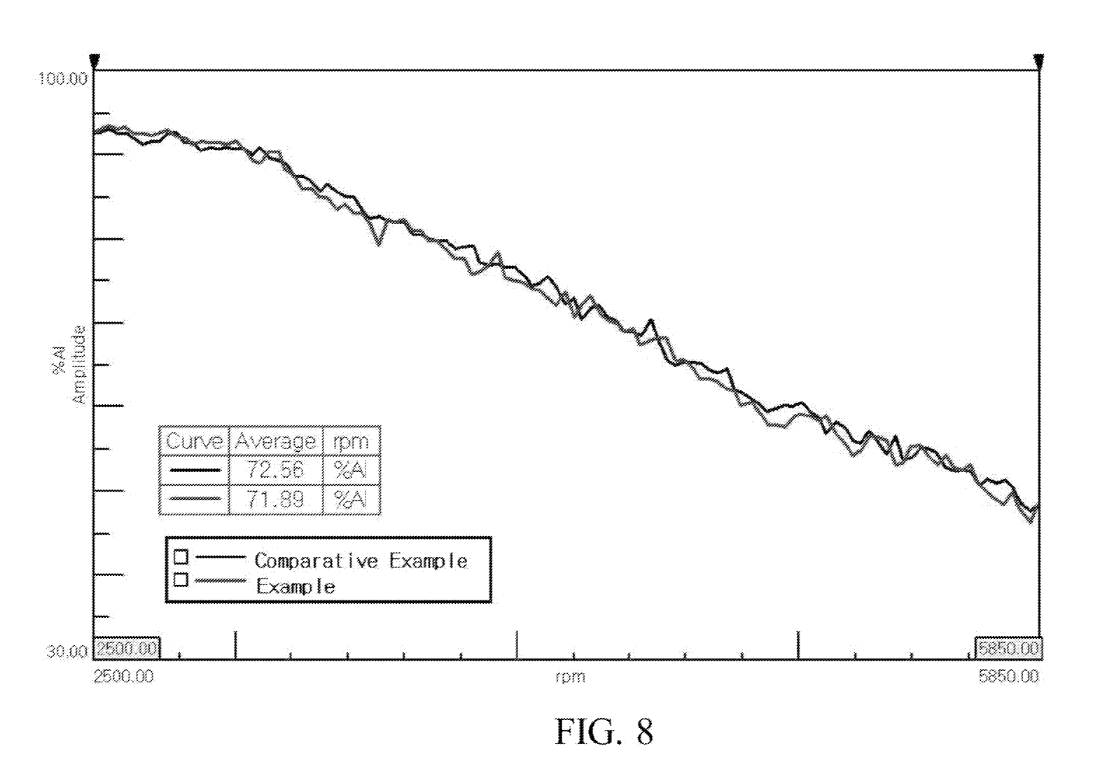

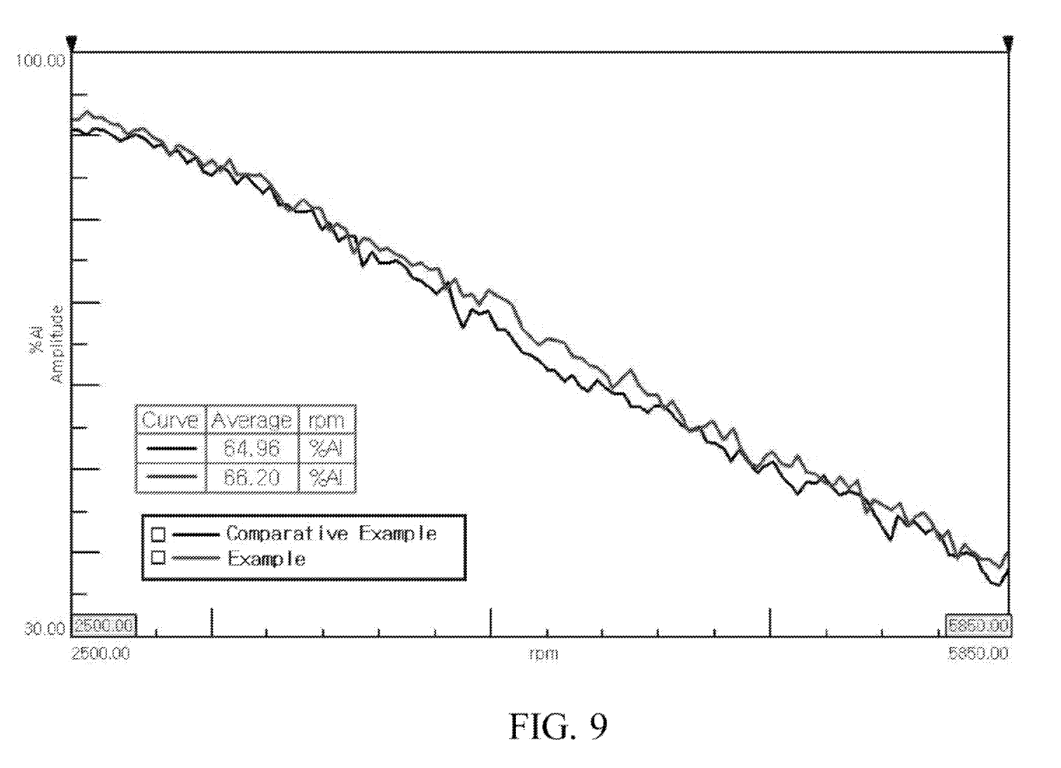

Results of the field test are shown in FIGS. 7 to 9. FIG. 7 shows the AI measured at the driver's seat, FIG. 8 is the AI measured at the passenger's seat, and FIG. 9 is the AI measured in the center of the back seat.

As shown in FIGS. 7 to 9, it can be noted that the example represented with a red line shows a higher AI than the comparative example represented with a black line. This is because another level of sound insulation is performed using the second sound-insulating layer. In addition, it can be confirmed that the sound-absorbing and insulating material of the example is slightly heavier, but has better sound-insulating performance than that of the comparative example.

Accordingly, in Example 3, it can be noted that, as a sound-insulating layer is formed by partially spray-coating a polyurethane sound-insulating composition according to the present invention on a part that has poor sound insulation and thus requires sound insulation, the increase in weight is minimized and sound-insulating performance is improved.

A polyurethane sound-insulating composition and a method of fabricating a sound-absorbing and insulating material for vehicles according to the present invention have the following effects.

(1) As a sound-insulating layer is formed by spray-coating a sound-absorbing material with the polyurethane sound-insulating composition, light weight and improved sound-insulating performance can be obtained, and particularly, since the sound-insulating layer is formed through the above-described spray-coating method, physical properties can be improved in addition to processability and flexibility.

(2) Particularly, although the polyurethane sound-insulating material can be spray-coated on an entire surface of the sound-absorbing layer, by spray-coating only a part of the sound-absorbing layer having a poorer sound-insulation effect than the rest of the sound-absorbing material with the polyurethane sound-insulating material, sound-insulating performance can be maximally improved, and therefore an increase in weight of the sound absorbing and insulating material with respect to the sound-insulating performance can be minimized.

(3) Likewise, in the present invention, the sound-insulating layer is formed by spray-coating with the polyurethane sound-insulating composition, and therefore various types of spray-coating can be used without a concern of coating an unnecessary part or a scrap, and a degree of freedom in shape can increase. Accordingly, processability, flexibility, and physical properties can be improved.

(4) Since the composition is a non-solvent type, problems of odors in conventional sound-insulating compositions using ethylene vinyl acetate as a base material can be solved.

While the present invention has been shown and described with reference to certain exemplary embodiments thereof, it will be understood by those skilled in the related art that various changes in form and details may be made therein without departing from the gist and scope of the present invention as defined by the appended claims.

What is claimed is:

1. A polyurethane sound-insulating composition, comprising:
a polyether polyol resin at 15 to 30 wt %, modified methylene bisphenyl diisocyanate at 10 to 25 wt %, and an inorganic filler at 55 to 75 wt %.

2. The composition according to claim 1, wherein the inorganic filler includes at least one of barium sulfate (BaSO₄), calcium carbonate (CaCO₃) and mica, or is prepared by mixing barium sulfate (BaSO₄) and calcium carbonate (CaCO₃) at a ratio of 1:99 to 99:1.

3. The composition according to claim 2, wherein the polyurethane sound-insulating composition has a specific gravity of 1.0 to 2.0.

4. A method of manufacturing a sound-absorbing and insulating material for vehicles, comprising:
forming a first sound-insulating layer 20 by spray-coating a surface of a first sound-absorbing layer with the polyurethane sound-insulating composition of claim 1.

5. The method according to claim 4, wherein a second sound-absorbing layer is further stacked on the first sound-insulating layer.

6. The method according to claim 5, wherein a second sound-insulating layer is further included between the first sound-insulating layer and the second sound-absorbing layer.

7. The method according to claim 4, wherein the first sound-insulating layer includes the polyether polyol resin, the modified methylene bisphenyl diisocyanate and the inorganic filler, which are as shown in the following table:

| Sprayed amount | | 80~120 | g/s |
|---|---|---|---|
| Particle size of inorganic filler | | 40 to 45 | μm |
| Pressure | Polyether polyol resin | 160 to 200 | bar |
| | Modified methylene bisphenyl | 180 to 240 | bar |
| | diisocyanate | | |
| Temperature | Polyether polyol resin | 60 to 70° | C. |
| | Modified methylene bisphenyl | 35 to 45° | C. |
| | diisocyanate | | |
| Viscosity | Polyether polyol resin | 1215 | MPa · s |
| | Modified methylene bisphenyl | 470 | MPa · s |
| | diisocyanate | | |

1) Sprayed amount: an amount of the sound-insulating composition according to the present invention that is sprayed to form the sound-insulating layer 20.
2) The inorganic filler is barium sulfate (BaSO₄).
3) The viscosity is measured at 25° C.
wherein the first sound-insulating layer is formed by spray-coating a composition prepared by forming a urethane bond between the polyether polyol resin and the modified methylene bisphenyl diisocyanate prepared by a reaction of polypropylene glycol under the temperature, pressure and viscosity conditions described above, and adding an inorganic filler.

8. The method according to claim 5, wherein each of the first sound-absorbing layer and the second sound-absorbing layer is formed of a polyurethane foam or hard polyethylene terephthalate (PET).

9. The method according to claim 6, wherein the second sound-insulating layer is a TPE sheet or a heavy layer.

10. The method according to claim 4, wherein the first sound-insulating layer is spray-coated on 70 to 100% of an entire surface of the first sound-absorbing layer to have a thickness of 0.5 to 3.0 mm.

11. A method of manufacturing a sound-absorbing and insulating material for vehicles, comprising:
forming a first sound-insulating layer by spray-coating a surface of a first sound-absorbing layer with the polyurethane sound-insulating composition of claim 2.

12. A method of manufacturing a sound-absorbing and insulating material for vehicles, comprising:
forming a first sound-insulating layer by spray-coating a surface of a first sound-absorbing layer with the polyurethane sound-insulating composition of claim 3.

13. The method according to claim 5, wherein the first sound-insulating layer 20 includes the polyether polyol resin, the modified methylene bisphenyl diisocyanate and the inorganic filler, which are as shown in the following table:

| Sprayed amount | | 80~120 | g/s |
|---|---|---|---|
| Particle size of inorganic filler | | 40 to 45 | μm |
| Pressure | Polyether polyol resin | 160 to 200 | bar |
| | Modified methylene bisphenyl | 180 to 240 | bar |
| | diisocyanate | | |
| Temperature | Polyether polyol resin | 60 to 70° | C. |
| | Modified methylene bisphenyl | 35 to 45° | C. |
| | diisocyanate | | |
| Viscosity | Polyether polyol resin | 1215 | MPa · s |
| | Modified methylene bisphenyl | 470 | MPa · s |
| | diisocyanate | | |

1) Sprayed amount: an amount of the sound-insulating composition according to the present invention that is sprayed to form the sound-insulating layer 20.
2) The inorganic filler is barium sulfate (BaSO₄).
3) The viscosity is measured at 25° C.
wherein the first sound-insulating layer is formed by spray-coating a composition prepared by forming a urethane bond between the polyether polyol resin and the modified methylene bisphenyl diisocyanate prepared by a reaction of polypropylene glycol under the temperature, pressure and viscosity conditions described above, and adding an inorganic filler.

14. The method according to claim 6, wherein the first sound-insulating layer includes the polyether polyol resin, the modified methylene bisphenyl diisocyanate and the inorganic filler, which are as shown in the following table:

| Sprayed amount | | 80~120 | g/s |
|---|---|---|---|
| Particle size of inorganic filler | | 40 to 45 | μm |
| Pressure | Polyether polyol resin | 160 to 200 | bar |
| | Modified methylene bisphenyl | 180 to 240 | bar |
| | diisocyanate | | |
| Temperature | Polyether polyol resin | 60 to 70° | C. |
| | Modified methylene bisphenyl | 35 to 45° | C. |
| | diisocyanate | | |
| Viscosity | Polyether polyol resin | 1215 | MPa · s |
| | Modified methylene bisphenyl | 470 | MPa · s |
| | diisocyanate | | |

1) Sprayed amount: an amount of the sound-insulating composition according to the present invention that is sprayed to form the sound-insulating layer 20.
2) The inorganic filler is barium sulfate (BaSO₄).
3) The viscosity is measured at 25° C.
wherein the first sound-insulating layer is formed by spray-coating a composition prepared by forming a urethane bond between the polyether polyol resin and the modified methylene bisphenyl diisocyanate prepared by a reaction of polypropylene glycol under the temperature, pressure and viscosity conditions described above, and adding an inorganic filler.

15. The method according to claim 6, wherein each of the first sound-absorbing layer and the second sound-absorbing layer is formed of a polyurethane foam or hard polyethylene terephthalate (PET).

16. The method according to claim 5, wherein the first sound-insulating layer is spray-coated on 70 to 100% of an entire surface of the first sound-absorbing layer to have a thickness of 0.5 to 3.0 mm.

17. The method according to claim 6, wherein the first sound-insulating layer is spray-coated on 70 to 100% of an entire surface of the first sound-absorbing layer to have a thickness of 0.5 to 3.0 mm.
